(19) United States
(12) Patent Application Publication
(10) Pub. No.: US 2003/0142605 A1
(43) Pub. Date: Jul. 31, 2003

(54) Optical head device and optical disk device

(75) Inventor: Sou Ishika, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/325,414

(22) Filed: Dec. 19, 2002

(30) Foreign Application Priority Data
Jan. 30, 2002 (JP) JP2002-22314

(51) Int. Cl. G11B 7/125

(52) U.S. Cl. 369/53.26

(57) ABSTRACT

An optical head device includes a light source for emitting a light beam and a focusing device for focusing the light beam onto a recording medium. An optical path directs the light beam from the light source toward the recording medium. The optical path directs a first portion of the light beam to fall upon the focusing device. A second portion of the light beam does not fall upon the focusing device. A light detector is positioned such that a light receiving face of the light detector is approximately perpendicular to an advancing direction of the second portion of the light beam and detects an amount of light in the second portion of the light beam for control of the power of the light beam emitted from the light source. Thus, APC processing is performed without reducing utilization efficiency of the laser beam of a trunk system.

### RELATED APPLICATIONS

This application is based upon and claims the benefit of priority from prior Japanese Patent Application No. 2002-22314, filed Jan. 30, 2002, the entire contents of which are incorporated herein by reference.

### BACKGROUND OF THE INVENTION

1. Field of the Invention

The present invention relates to an optical head device and method utilized for recording/reading information to/from a recording medium using a laser beam, and to an optical disk device using the optical head device.

2. Description of the Related Art

As is well known, a digital versatile disk (DVD) used as a recording medium provides higher density recordings than a compact disk (CD), even though a DVD is the same size (12 cm diameter) as a conventional CD for recording audio and digital data. Such a DVD requires a beam wavelength of 650 nm, which is shorter than the wavelength of 780 nm for reading data of the CD since the recording density of the DVD is quite high.

It is desirable for a recording/reproducing device to be able to perform recording and regenerating operations in a disk system for both a CD and a DVD. Therefore, a device having a first light source (with a wavelength of 650 nm) for the DVD and a second light source (with a wavelength of 780 nm) for the CD has been developed as an optical head device using a semiconductor array. Thus, the optical head device has the first light source (for the DVD) and the second light source (for the CD).

A laser beam emitted from the first light source is transmitted through a hologram, and is incident on (i.e., falls upon) a dichroic polarized beam splitter (hereinafter called a dichroic PBS) able to perform optical synthesis and optical branching. The laser beam transmitted through this dichroic PBS is changed to collimator light through a collimator lens and is incident on an objective lens. The objective lens converges the light and directs it to a recording face of the disk.

The light reflected from the disk is incident on the hologram through the objective lens, the collimator lens and the dichroic PBS. The reflected light is diffracted by the hologram and is directed to a photodetector using a photo diode. The photodetector outputs a focusing error signal, a tracking error signal and a reproducing signal.

A laser beam emitted from the second light source is incident on the Dichroic PBS. The laser beam reflected and emitted within this Dichroic PBS is changed to collimator light through the collimator lens, and is incident on the objective lens. The objective lens focuses or converges the laser beam and directs it to the recording face of the disk.

The light reflected from the disk is incident on the hologram through the objective lens, the collimator lens and the Dichroic PBS. The reflected light diffracted by the hologram is directed to the above described photodetector using a photo diode.

In an apparatus using the above described optical head device, an automatic power control circuit (hereinafter called an APC circuit) is arranged to stabilize the intensity of the laser beam directed toward the disk. For example, this APC circuit branches one portion of the reflected light from the disk by the Dichroic PBS, and directs this light portion to the photodetector for APC and measures an amount of light of this light portion. Conventionally, driving power (for supplying electric current) for the light source is controlled in accordance with measured results of the amount of light so that the intensity of the laser beam directed toward the disk is stabilized.

The above described conventional APC circuit uses one portion of the laser beam of a trunk system (emitting path, reflecting path) to detect the light for APC, and thus there occurs a loss of power of the laser beam of the trunk system and reduced efficiency.

For example, Jpn. Pat. Appln. KOKAI Publication No. 5-273491, is a publicly known example relative to APC processing with respect to the light source. However, this KOKAI Publication does not provide a practical solution to the above mentioned problems.

### BRIEF SUMMARY OF THE INVENTION

Embodiments of the present invention provide an optical head device, an optical disk device and method for advantageously performing APC processing with respect to a light source without reducing utilization efficiency of the laser beam of a trunk system.

According to an embodiment of the present invention, there is provided an optical head device having a light source for emitting a light beam and a focusing device for focusing the light beam onto a recording medium. The optical head device comprises an optical path for directing the light beam from the light source toward the recording medium. The optical path includes a first region directing a first portion of the light beam to fall upon the focusing device, and a second region directing a second portion of the light beam not to fall upon the focusing device. The second portion is parallel to the first portion. The optical head device further comprises a light detector for detecting an amount of light in the second portion of the light beam. The light detector is positioned such that a light receiving face of the light detector is approximately perpendicular to an advancing direction of the second portion of the light beam.

According to another embodiment of the present invention, there is provided an optical disk device having a light source for emitting a light beam and a focusing device for directing the light beam onto a recording medium via an optical path having a first region for directing a first portion of the light beam to fall upon the focusing device, and a second region for directing a second portion of the light beam parallel to the first portion not to fall upon the focusing device. The optical disk device comprises a photodetector positioned such that a light receiving face of the photodetector is approximately perpendicular to an advancing direction of the second portion of the light beam. The photodetector detects an amount of light of the second portion of the light beam. The optical disk device further includes a system control section for controlling a parameter of the light beam emitted from the light source based on the detected amount of light. The parameter may be an amount of power of the light beam emitted from the light source.

According to another embodiment of the present invention, there is provided a method of directing a light beam from a light source toward a recording medium along an optical path. A first region of the optical path directs a first portion of the light beam to fall upon a focusing device, and a second region of the optical path directs a second portion of the light beam not to fall upon the focusing device. The second portion is parallel to the first portion.

A light detector is positioned such that a light receiving face of the light detector is approximately perpendicular to an advancing direction of the second portion of the light beam. The light detector detects an amount of light of the second portion of the light beam and utilizes the detected amount of light to control an amount of power of the light beam emitted from the light source.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1A is a plan view showing the structure of an optical head device, according to embodiments of the invention;

FIG. 1B is a side view showing the structure of an optical head device, according to embodiments of the invention;

FIG. 2 is a view illustrating the position relation of a laser beam emitted from a dichroic PBS of the optical head device shown in FIG. 1 and a photodetector for APC, according to embodiments of the invention;

FIG. 3 is a plan view showing an optical disk device using the optical head device, according to embodiments of the invention; and

FIG. 4 is a block diagram illustrating one example of an electric signaling system for processing a signal read by the optical head device, according to embodiments of the invention.

### DETAILED DESCRIPTION OF THE INVENTION

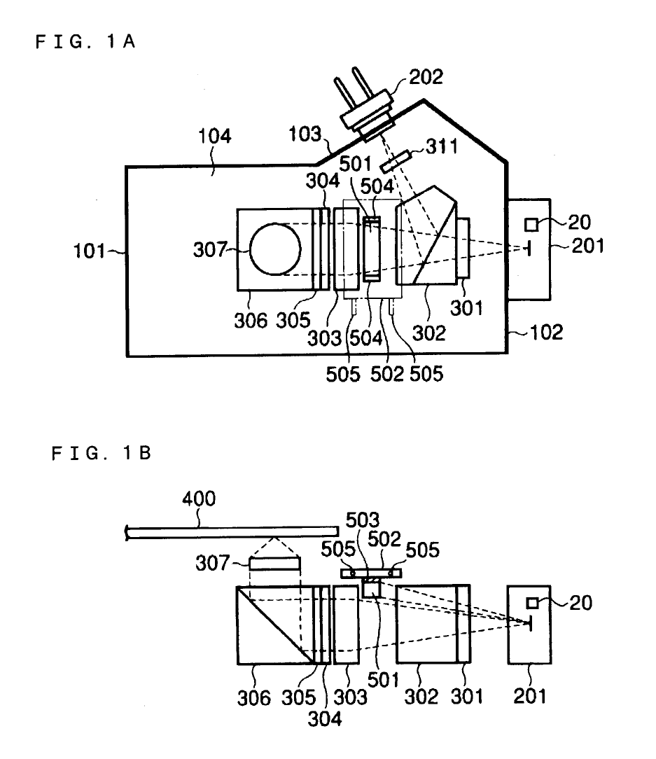

Embodiments of the present invention will next be described in detail with reference to the drawings. FIGS. 1A and 1B show the structure of an optical head device according to an embodiment of the present invention. FIG. 1A is a plan view of this structure and FIG. 1B is a side view of this structure. Embodiments of the present invention will be described with reference to both of these figures.

A first light source unit 201 is attached to one side wall 102 of a chassis 101. This first light source unit 201 is a light source for a DVD emitting a laser beam of a wavelength of 650 nm.

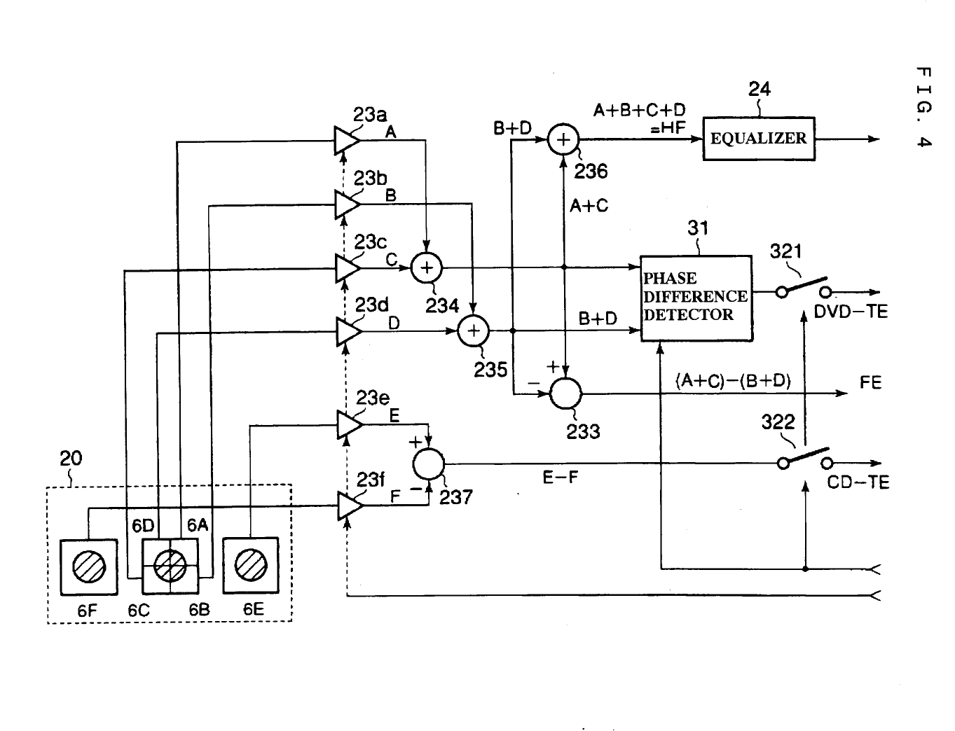

A photodetector 20 (see also FIG. 4) for photoelectrically converting reflected light from an optical disk 400 diffracted by a hologram 301 is arranged within this first light source unit 201. This photodetector 20 obtains a reproducing signal, a focusing error signal and a tracking error signal by photoelectrically converting the reflected light from the optical disk 400.

Further, a second light source unit 202 is attached to another side wall 103 of the chassis 101. This second light source unit 202 is a light source for a CD emitting a laser beam of a wavelength of 780 nm.

Thus, the optical head device has the first light source (for the DVD) and the second light source (for the CD). The laser beam emitted from the first light source unit 201 is radiated in a plane 104 of the chassis 101 in a direction approximately parallel to this plane 104, and is incident on a dichroic polarized beam splitter (PBS) 302 through the hologram 301.

The laser beam from the first light source unit 201 is directed to the dichroic PBS 302 via the hologram 301, and is then changed to parallel fight by a collimator lens 303, and is incident on a reflecting mirror (prism) 306 through each of a tilt correcting element 304 and a ¼ wavelength plate 305.

The laser beam reflected from this reflecting mirror 306 is incident on an objective lens 307 arranged above the reflecting mirror 306. Objective lens 307 focuses the laser beam on a reflecting layer (information recording face) of the optical disk 400 arranged above the objective lens 307.

The light reflected from the information recording face of this optical disk 400 is returned to the ¼ wavelength plate 305 through the objective lens 307 and the reflecting mirror 306. The reflected light transmitted through this ¼ wavelength plate 305 is incident on the dichroic PBS 302 through the tilt correcting element 304 and collimator lens 303.

The reflected light incident on this dichroic PBS 302 is then diffracted by the hologram 301. The diffracted reflected light is incident on the photodetector 20 within the first light source unit 201, and is supplied to generate the reproducing signal, the focusing error signal and the tracking error signal mentioned above.

The laser beam emitted from the second light source unit 202 is radiated in the plane 104 of the chassis 101 in a direction approximately parallel to this plane 104, and is incident on the dichroic PBS 302 through a ½ wavelength plate 311.

The laser beam from the second light source unit 202 is reflected within the dichroic PBS 302 and is directionally converted and is incident on the collimator lens 303. The laser beam incident on the collimator lens 303 is changed to parallel light and is incident on the reflecting mirror (prism) 306 through each of the tilt correcting element 304 and the ¼ wavelength plate 305.

The laser beam reflected from this reflecting mirror 306 is incident on the objective lens 307 arranged above the reflecting mirror 306. The laser beam focused by this objective lens 307 is directed to the reflecting layer (information recording face) of the optical disk 400 located above the objective lens 307.

The light reflected from the information recording face of this optical disk 400 is returned to the ¼ wavelength plate 305 through the objective lens 307 and the reflecting mirror 306. The reflected light transmitted through the ¼ wavelength plate 305 is incident on the dichroic PBS 302 through the tilt correcting element 304 and collimator lens 303.

The reflected light incident on this dichroic PBS 302 is diffracted by the hologram 301. The diffracted reflected light is incident on the photodetector 20 within the first light source unit 201, and is supplied to generate the reproducing signal, the focusing error signal and the tracking error signal mentioned above.

Here, the optical head device described in this embodiment has a photodetector for detecting power of one light portion of the laser beam selectively emitted from the first and second light source units 201, 202 to perform automatic power control (APC) processing. Specifically, a photodetector 501 for APC is interposed between the dichroic PBS 302 and the collimator lens 303. This photodetector 501 is arranged around an optical path of the laser beam selectively emitted from the first and second light source units 201, 202 and directed to the objective lens 307. Thus, the photodetector 501 is arranged in a region of light not incident on the objective lens 307, i.e., a region of light practically unused by the objective lens 307.

In operation, this photodetector 501 receives a portion of the laser beam (including the laser beam emitted from both the first and second light source units 201, 202) incident on the collimator lens 303 through the dichroic PBS 302, but not incident on the objective lens 307, and photoelectrically converts this received portion of the laser beam.

Therefore, it is possible to detect the power of the laser beam selectively emitted from the first and second light source units 201, 202 without influencing the amount of light incident on the objective lens 307 so that APC processing can be performed with respect to the first and second light source units 201, 202.

This photodetector 501 for APC is attached, for example, to a printed wiring board 502 supported by the chassis 101 through an adhesive 503. This photodetector 501 is electrically connected to the exterior by connecting an electrode 504 for connection formed in each of both end portions of this photodetector 501 to an electrode terminal 505 formed in the printed wiring board 502.

The objective lens 307 is held by an unillustrated lens holder. The lens holder is supported by one end portion of plural wires, and can be controlled such that the lens holder is moved slightly in a focusing direction and a tracking direction. The plural wires are held by a wire holder attached to the chassis 101.

For example, a compact permanent magnet for focusing control and a compact permanent magnet for tracking control are attached to the lens holder. A yoke coil for focusing control and a yoke coil for tracking control are arranged in the chassis in proximity to these permanent magnets.

The objective lens 307 can be controlled by respectively supplying a focusing control signal and a tracking control signal to the yoke coil for focusing control and the yoke coil for tracking control so as to be moved slightly in a focus control direction and a tracking control direction.

In accordance with the above described embodiment, loss of the laser beam of a trunk system incident on an objective lens can be avoided. Thus, utilization efficiency of the laser beam can be increased. As a result, the APC processing can be performed with respect to the first and second light source units 201, 202 without reducing the utilization efficiency of the laser beam of the trunk system.

In the above described embodiment, when the power of the laser beam from each of the first and second light source units 201, 202 is detected, this power can be detected by using one photodetector 501. However, it is not necessary to arrange plural light sources, and embodiments of the present invention may also be applied to an optical head having one light source.

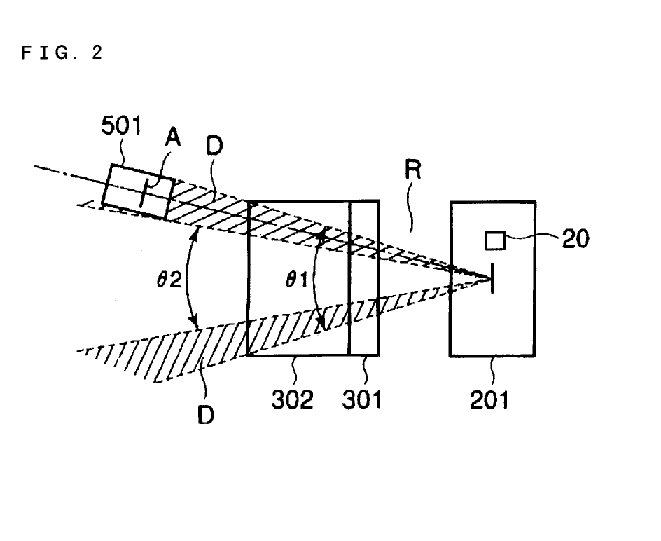

FIG. 2 shows the position relation of a laser beam R emitted from the dichroic PBS 302 toward the collimator lens 303, and the photodetector 501 for APC. As an example, the laser beam R emitted from the first light source unit 201 is incident on the collimator lens 303 through the hologram 301 and the dichroic PBS 302 while this laser beam R is normally widened at an angle θ1.

The laser beam R incident on the collimator lens 303 is converted to parallel light with its optical axis as a center. This parallel light is incident on the objective lens 307 and is converged. At this time, the laser beam R incident on the objective lens 307 becomes a light beam in the range of an angle θ2 narrower than the angle θ1.

Therefore, as a result, the optical path of the laser beam may be said to include two parallel regions. A first region of the optical path (that portion within θ2) directs a portion of the laser beam to fall upon the objective lens 307 of the trunk system (a trunk system optical path). A second normally unused region D of the optical path (shown by the slanting lines in FIG. 2) directs another portion of the laser beam not to fall upon the objective lens 307 of the trunk system (optical path outside the trunk system). Because the two regions of the optical path are parallel to one another, the first and second portions of the laser beam are also parallel to one another. The second portion of the laser beam shifted from the trunk system optical path (or effective region) is also called stray or fringe light.

The light beam of this optical area D (or non-effective area) is effectively and practically used according to embodiments of the present invention. Specifically, if a light receiving face A of the photodetector 501 for APC is arranged in this optical area D, one portion of the laser beam R can be directed to the photodetector 501 without losing the light beam of the trunk system (without reducing a utilization rate of the light beam of the trunk system).

In one embodiment, as shown in FIG. 2, the photodetector 501 is arranged such that the light receiving face A of the photodetector 501 is approximately perpendicular to an advancing direction of the light beam in the optical area D. In this manner, the light beam can be preferably detected in the photodetector 501 and the APC processing can be realized with high accuracy.

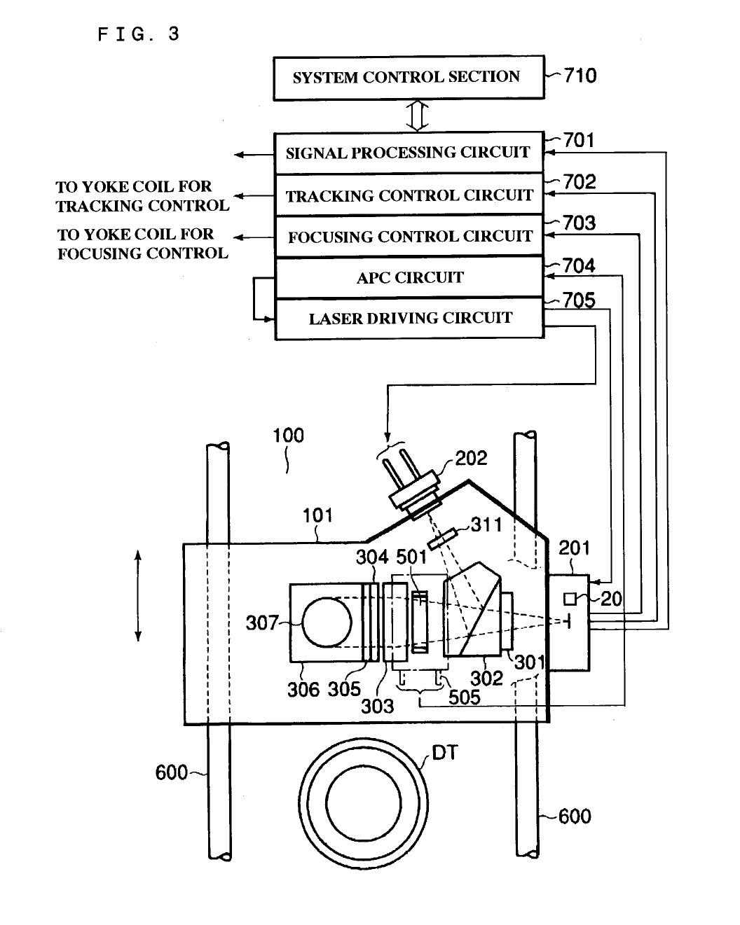

An embodiment of an optical disk device using the above described optical head device will next be described. In FIG. 3, DT designates a disk table for holding the optical disk 400 as a recording medium. This disk table DT is rotated by a disk motor controlled by a servo circuit.

Reference numeral 100 designates the optical head device. As described with reference to FIG. 1, the laser beam is directed to the information recording face of the optical disk 400 held by the disk table DT and rotated at a predetermined speed. The light reflected from the information recording face of the optical disk 400 is taken in and an electric signal corresponding to intensity of this reflected light is outputted.

The optical head device 100 can be moved in a direction perpendicular to the tangential direction of a track formed on the information recording face of the optical disk 400 along guide rails 600 arranged in a predetermined position relation with respect to the disk table DT. Namely, the optical head device 100 can be moved in a radial direction of the optical disk 400, i.e., in a tracking control direction. Further, the optical head device 100 is reciprocated on the guide rails 600 by a feed motor.

An output signal of the photodetector 20 for receiving the reflected light from the optical disk 400 is directed to a signal processing circuit 701, a tracking control circuit 702 and a focusing control circuit 703. The signal processing circuit 701 executes arithmetic processing for reproducing information recorded to the optical disk 400.

The tracking control circuit 702 generates a tracking error signal by arithmetically processing a signal obtained from the optical disk 400, and also generates a tracking control signal supplied to the above described yoke coil for tracking control. The focusing control circuit 703 generates a focusing error signal by arithmetically processing the signal obtained from the optical disk 400, and also generates a focusing control signal supplied to the above described yoke coil for focusing control.

A detecting signal of the photodetector 501 is directed to the APC circuit 704. The APC circuit 704 determines whether the inputted detecting signal is a signal at a preset level, and supplies a control signal obtained on the basis of this determination to a laser driving circuit 705.

When the first light source unit 201 is set to an operating state, the laser driving circuit 705 controls the power of the laser beam of the first light source unit 201 in accordance with the inputted control signal. When the second light source unit 202 is set to an operating state, the laser driving circuit 705 controls the power of the laser beam of the second light source unit 202 in accordance with the inputted control signal.

Thus, the power of the output laser beam or the amount of reflected light from the optical disk 400 is automatically controlled so as to lie within the range of a preset standard.

A semiconductor laser element for emitting the light beam of a predetermined wavelength is used in each of the above described first and second light source units 201, 202.

The objective lens 307 is movably supported by the above described lens holder in a radial direction of the optical disk 400 and a traveling direction (a direction perpendicular to the information recording face of the optical disk 400, i.e., in/out of the plane of the paper) of the laser beam.

The radial direction of the optical disk 400 is called the tracking control direction. The direction perpendicular to the information recording face of the optical disk 400 is called the focusing control direction.

The tracking control circuit 702 generates the tracking control signal from the tracking error signal, and supplies the tracking control signal to the above described yoke coil for tracking control. The focusing control circuit 703 generates the focusing control signal from the focusing error signal, and supplies the focusing control signal to the above described yoke coil for focusing control.

A system control section 710 controls, via control signals, the operation timing of the optical disk device. The system control section 710 also sets operating parameters for the optical disk device via the control signals. A power device, a ROM (Read Only Memory) storing a program read in operating the device itself, a RAM (Random Access Memory) for temporarily storing data read from the optical disk 400 or data inputted from a host computer, etc. and control data, etc. are arranged in this optical disk device.

During the reproducing operation, the laser driving circuit 705 is modulated in accordance with the record information, and average power of the laser beam is controlled by the APC circuit 704 so as to reach a recording level. Although in the embodiment of the present invention described above, an operation for reproducing information from the optical disk 400 is described, embodiments of the present invention may also be applied to an information record stored on other types of recording media, including, but not limited to, digital versatile disk-random access memory (DVD-RAM).

The relation of the signal processing circuit 701, the tracking control circuit 702, the focusing control circuit 703 and the photodetector in relation to the first light source unit 201 will next be described. A signal processing system described below is one example, and does not limit the main features of the present invention.

FIG. 4 shows one example of an electric signaling system for processing a signal read by the optical head device 100. Photo diodes 6A, 6B, 6C, 6D, 6E and 6F are arranged in the photodetector 20. Outputs of the respective photo diodes 6A, 6B, 6C, 6D, 6E and 6F are inputted to buffer amplifiers 23a, 23b, 23c, 23d, 23e and 23f. Respective signals A, B, C, D, E and F outputted from the buffer amplifiers 23a, 23b, 23c, 23d, 23e, 23f are arithmetically calculated as follows.

An adder 234 generates a (A+C) signal, and an adder 235 generates a (B+D) signal. An adder 236 adds the (A+C) signal from the adder 234 and the (B+D) signal from the adder 235, and generates a (A+B+C+D) signal. This (A+B+C+D) signal is outputted as a high frequency signal HF through an equalizer 24, and is processed in the above described signal processing circuit 701.

The (A+C) signal from the adder 234 and the (B+D) signal from the adder 235 are also inputted to a phase difference detector 31. An output of the phase difference detector 31 is used as a tracking error signal (DVD-TE) for DVD when switch 321 is closed.

Further, the (A+C) signal from the adder 234 and the (B+D) signal from the adder 235 are inputted to a subtracter 233. The output signal of this subtracter 233, (A+C)−(B+D), is used as a focusing error signal FE for DVD or CD.

The subtracter 237 generates a (E−F) signal. This (E−F) signal is obtained based on the detecting signal of a sub-beam and is disregarded by turning off a switch 322 during a DVD reproducing mode. The (E−F) signal is used as a tracking error signal (CD-TE) for CD. Namely, when the optical disk device is set to a CD reproducing mode, the switch 322 is turned on (closed), with switch 321 thus being turned off (open).

In accordance with the above described embodiments of the present invention, while a laser beam of a trunk system travels along an optical path between a light source and an objective lens, a portion of the laser beam not incident on the objective lens is detected to control power of the laser beam emitted from the light source. In this manner, APC processing can be performed with respect to the light source without reducing utilization efficiency of the laser beam.

Having disclosed exemplary embodiments and the best mode, modifications and variations may be made to the disclosed embodiments while remaining within the scope of the invention as defined by the following claims.

What is claimed is:

1. An optical head device having a light source for emitting a light beam and a focusing device for focusing the light beam onto a recording medium, comprising:
an optical device for directing said light beam along an optical path from said light source toward said recording medium, a first region of said optical path corresponding to a first portion of said light beam falling upon said focusing device, and a second region of said optical path corresponding to a second portion of said light beam not to fall upon said focusing device; and
a light detector for detecting an amount of light in said second portion of said light beam, said light detector positioned such that a light receiving face of said light detector is approximately perpendicular to an advancing direction of said second portion of said light beam.

2. The optical head device according to claim 1, wherein said light detector utilizes said detected amount of light to control an amount of power of said light beam emitted from said light source.

3. The optical head device according to claim 1, wherein said focusing device is an objective lens.

4. The optical head device according to claim 1, wherein said optical device includes a beam splitter for optically branching said light beam emitted from said light source and directing said first portion of said light beam to said focusing device and said second portion of said light beam to said light detector.

5. The optical head device according to claim 4, wherein said optical device further includes a collimator lens positioned downstream of said beam splitter for converting said first portion of said light beam to parallel light and for directing said parallel light to said focusing device, said light detector positioned between said beam splitter and said collimator lens.

6. The optical head device according to claim 1, wherein said recording medium is at least one of a digital versatile disk (DVD), a compact disk (CD) and digital versatile disk-random access memory (DVD-RAM).

7. An optical disk device having a light source for emitting a light beam and a focusing device for directing said light beam onto a recording medium via an optical path having a first region corresponding to a first portion of said light beam falling upon said focusing device, and a second region corresponding to a second portion of said light beam not falling upon said focusing device, said optical disk device comprising:
a photodetector positioned such that a light receiving face of said photodetector is approximately perpendicular to an advancing direction of said second portion of said light beam, said photodetector for detecting an amount of light of said second portion of said light beam; and
control means for controlling a parameter of said light beam emitted from said light source based on said detected amount of light from said photodetector.

8. The optical disk device according to claim 7, wherein said parameter is an amount of power of said light beam emitted from said light source.

9. The optical disk device according to claim 7, wherein said focusing device is an objective lens.

10. The optical disk device according to claim 7, wherein said first portion of said light beam is converted to parallel light and is directed to said focusing device by a collimator lens arranged between said light source and said focusing device.

11. The optical disk device according to claim 7, wherein said optical device includes a beam splitter for optically branching said light beam emitted from said light source and directing said first portion of said light beam to said focusing device and said second portion of said light beam to said photodetector.

12. The optical disk device according to claim 7, wherein said recording medium is at least one of a digital versatile disk (DVD), a compact disk (CD) and digital versatile disk-random access memory (DVD-RAM)

13. In an optical head device having a light source for emitting a light beam and a focusing device for focusing the light beam onto a recording medium, a method of controlling power from said light source, the method comprising:
directing said light beam from said light source toward said recording medium along an optical path, a first portion of said light beam falling upon said focusing device, and a second portion of said light beam not falling upon said focusing device;
detecting an amount of light of said second portion of said light beam with a light detector having a light receiving face approximately perpendicular to an advancing direction of said second portion of said light beam; and
utilizing said detected amount of light of said second portion of said light beam to control said power.

14. The method according to claim 13, wherein said focusing device is an objective lens.

15. The method according to claim 13, wherein a collimator lens is included within said optical path, said collimator lens converting said first portion of said light beam to parallel light and directing said parallel light to said focusing device.

16. The method according to claim 13, wherein a beam splitter is included in said optical path, said beam splitter optically branching said first portion of said light beam to said focusing device and said second portion of said light beam to said light detector.

17. The method according to claim 13, wherein said recording medium is at least one of a digital versatile disk (DVD), a compact disk (CD) and digital versatile disk-random access memory (DVD-RAM).

18. The method according to claim 13, further comprising:
positioning said light detector between a collimator and a beam splitter.
